(19) United States
(12) Patent Application Publication
(10) Pub. No.: US 2012/0104749 A1
(43) Pub. Date: May 3, 2012

(54) TUBE COUPLING

(75) Inventor: Ki Hwan KANG, Seoul (KR)

(73) Assignee: STORM TEC CO., LTD, Seoul (KR)

(21) Appl. No.: 13/344,064

(22) Filed: Jan. 5, 2012

Related U.S. Application Data
(63) Continuation of application No. PCT/KR2009/005220, filed on Sep. 14, 2009.

(30) Foreign Application Priority Data
Jul. 8, 2009 (KR) 10-2009-0062283

(51) Int. Cl. F16L 21/06

(52) U.S. Cl. 285/323

(57) ABSTRACT

The present invention relates to a tube coupling for connecting tubes for conveying a fluid. The present invention provides a tube coupling that may confine separation of a collet. The present invention also provides a tube coupling that may prevent plastic deformation of a collet to so that a reliability of the tube coupling is improved and a life span of the tube coupling is guaranteed. The present invention also provides a tube coupling that may interrupt a direct contact between a collet and an O-ring seal so that leakage of a fluid is prevented from occurring due to damage of an O-ring seal and a tube is guided to a center of the O-ring seal and is inserted in the O-ring seal.

### TECHNICAL FIELD

The present invention relates to a tube coupling for connecting tubes for conveying a fluid.

### BACKGROUND ART

Tubes, pipes, hoses, etc. are used for conveying various fluids such as water, oil, air, etc. Tube couplings are provided to connect tubes at a starting point and a finishing point of the flow of a fluid, so as to be able to convey the fluid from one position to another position. In addition, tube couplings are provided to connect tubes at a junction point at which the fluid is diverged in a third position.

Tube couplings for conveying a fluid can be easily found in many patent literatures such as U.S. Pat. Nos. 4,588,214, 4,606,783, 4,645,246, 5,930,969 et al. Tube couplings disclosed in the patent literatures include a coupling body, a collet, and an O-ring seal. The collet is inserted in a throughway via an open end of the coupling body and is connected to the throughway. A tube is inserted in the throughway of the coupling body via the collet. The O-ring seal is fitted to the throughway of the coupling body in order to maintain a hermetic seal between the coupling body and the tube.

A tube coupling having the above configuration is illustrated in FIGS. 1 and 2. As illustrated in FIG. 1, an O-ring seal 30 is moved to a collet 20 due to a liquid pressure of a liquid that is conveyed along a through pathway 12 of a coupling body 10, and the moved O-ring seal 30 is in contact with tips 24 of resilient arms 22 so that partial deformation and damage of the O-ring seal 30 occur and leakage of liquid occurs.

In addition, as illustrated in FIG. 2, when heads 26 of the collet 20 are in contact with a point P inside a tapered bore 14 and the tips 24 of the resilient arms 22 are pressed by a force that is generated in contact with the O-ring seal 30, moments act on the resilient arms 22 based on the point P. The resilient arms 22 are excessively separated from each other due to the moments that act on the resilient arms 22 based on the point P. When separation between the resilient arms 22 is maintained or repeated for a long time, the resilient arms 22 are plastic deformed. When the resilient arms 22 are excessively separated from each other or plastic deformed in this way, teeth 28 are not properly engaged with an outer surface of a tube 2 so that the tube 2 is easily detached from the collet 20 and the liquid leaks from the tube 2, resulting in fatal breakdown.

Meanwhile, many patents for solving problems that occur due to a contact between the collet and the O-ring seal have been suggested. A tube coupling disclosed in U.S. Pat. No. 7,032,932 includes a coupling body, a collet, an O-ring seal, and a spacer washer. The O-ring seal is fitted to a throughway of the coupling body in order to maintain a hermetic seal between the coupling body and a tube and is closely adhered to a step of the throughway. An outer surface of the tube is engaged with heads of the collet and is not easily detached from the collet. The spacer washer is fitted to a bore so that a position of the O-ring seal against the step is defined.

A tube coupling disclosed in U.S. Pat. No. 7,354,079 includes a connector body, a collet, a collar, an O-ring, and a guide. The O-ring is fitted to a passageway of the connector body in order to maintain a hermetic seal between the connector body and a tube. An outer surface of the tube is engaged with arcuate teeth of the collet and is not easily detached from the collet. The guide guides the tube that is inserted in the passageway of the connector body via an inside of the collet, to an inside of the O-ring.

A tube coupling disclosed in U.S. Pat. No. 7,425,022 includes a coupling, a collet, an O-ring seal, and a spacer washer. The O-ring seal is fitted to a throughway of the coupling in order to maintain a hermetic seal between the coupling and a tube and is closely adhered to a step of the throughway. An outer surface of the tube is engaged with heads of the collet and is not easily detached from the collet. The spacer washer is disposed between the collet and the O-ring seal. The heads of the collet are retained on a ramp of the spacer washer so as to release collet arms, i.e., resilient arms, which hold the tube when the tube passes through the collet.

However, in the tube couplings disclosed in U.S. Pat. Nos. 7,032,932, 7,354,079, and 7,425,022, the problems of separation and plastic deformation of resilient arms that occur when the spacer washer is in contact with a tip of the collet due to the liquid pressure, have not been solved. In particular, in the tube coupling disclosed in U.S. Pat. No. 7,425,022, since the heads of the collet are retained on the ramp of the spacer washer, separation and plastic deformation of the resilient arms increase so that a reliability of the tube coupling is greatly lowered.

### DETAILED DESCRIPTION OF THE INVENTION

### Technical Problem

The present invention provides a tube coupling that may confine separation of a collet.

The present invention also provides a tube coupling that may prevent plastic deformation of a collet to so that a reliability of the tube coupling is improved and a life span of the tube coupling is guaranteed.

The present invention also provides a tube coupling that may interrupt a direct contact between a collet and an O-ring seal so that leakage of a fluid is prevented from occurring due to damage of an O-ring seal and a tube is guided to a center of the O-ring seal and is inserted in the O-ring seal.

### Technical Solution

According to an aspect of the present invention, a tube coupling includes: a coupling body including a through pathway having an open end so as to connect tubes for conveying a fluid and a step that is formed in the through pathway towards the open end so as to expand a diameter of the through pathway; an end cap that is connected to the through pathway via the open end and includes a tapered bore through which the tube passes, wherein a diameter of the tapered bore is expanded towards the step of the coupling body; an O-ring seal that is fitted to the through pathway so as to maintain a hermetic seal between the coupling body and the tube, wherein a position of the O-ring seal is defined by the step of the coupling body; a collet including a sleeve through which the tube passes and a plurality of resilient arms extending from the sleeve so as to be able to be inserted in the through pathway, wherein a plurality of heads are formed so as to be able to be in contact with the tapered bore on an outer surface adjacent to a tip of each of the resilient arms, and a plurality of teeth are provided on an inner surface of the tube adjacent to the tip of each resilient arm so that an outer surface of the tube is engaged with the inner surface of the tube adjacent to the tip of each resilient arm; and a retainer ring that is fitted so as to be able to move along the through pathway between the O-ring seal and the collet, has a bore of small diameter where the tube is inserted and a bore of large diameter housing the heads to ensure that there is no separation between the resilient arms, and has a step that is formed between the bore of small diameter and the bore of large diameter such that tips of the resilient arms are in contact with the step.

### ADVANTAGEOUS EFFECTS

A tube coupling according to the present invention confines separation of a collet and prevents plastic deformation of the collet and thus conveys a fluid without leakage so that a reliability of the tube coupling may be improved and a life span of the tube coupling may be guaranteed.

### DESCRIPTION OF THE DRAWINGS

FIG. 1 is a cross-sectional view of a structure of a general tube coupling.

FIG. 2 is a cross-sectional view for explaining separation of resilient arms in the general tube coupling illustrated in FIG. 1.

FIG. 3 is a cross-sectional view of a structure of a tube coupling according to an embodiment of the present invention.

FIG. 4 is an exploded cross-sectional view of a structure of the tube coupling illustrated in FIG. 3.

FIG. 5 is an exploded perspective view of a structure of the tube coupling illustrated in FIG. 3.

FIG. 6 is a cross-sectional view of a structure of an O-ring seal, a collet, and a retainer ring of the tube coupling illustrated in FIG. 3.

FIG. 7 is a cross-sectional view for explaining an assembling state of the tube coupling illustrated in FIG. 3.

FIG. 8 is a cross-sectional view of a structure of the tube coupling illustrated in FIG. 3, assembling of the tube coupling is completed.

FIG. 9 is a cross-sectional view for explaining a state in which separation of resilient arms are confined by the retainer ring of the tube coupling illustrated in FIG. 3.

FIGS. 10 and 11 are cross-sectional views of retainer rings of the tube coupling illustrated in FIG. 3, according to embodiments of the present invention.

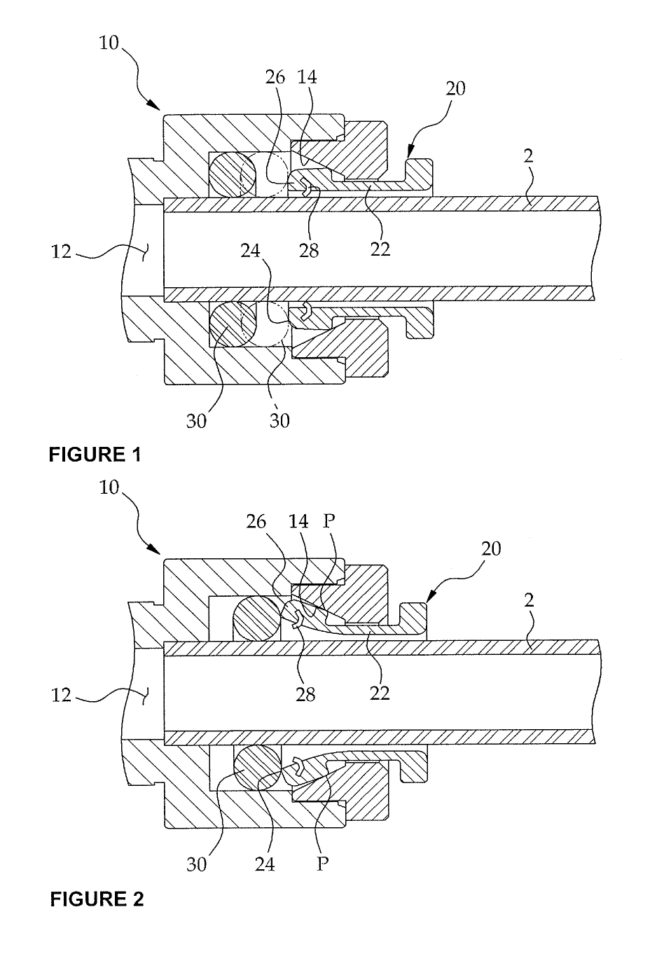

### MODE OF THE INVENTION

Other objectives, particular advantages, and novel features of the present invention will be more apparent from the following detailed description and exemplary embodiments that are associated with the attached drawings.

The present invention will now be described more fully with reference to the accompanying drawings, in which exemplary embodiments of the invention are shown.

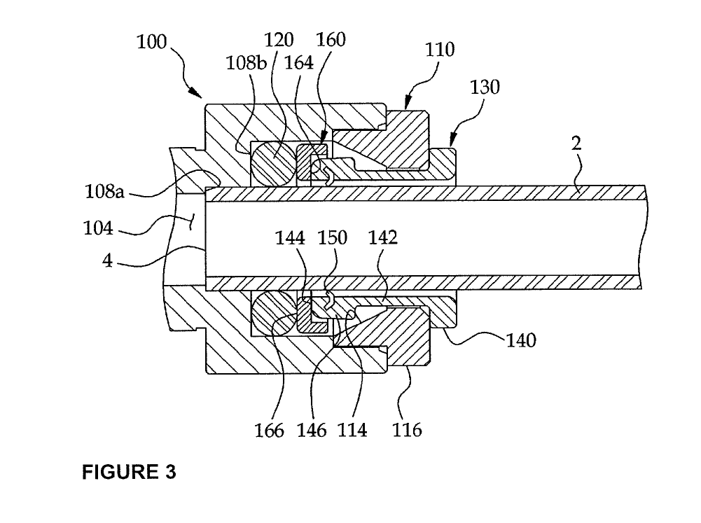

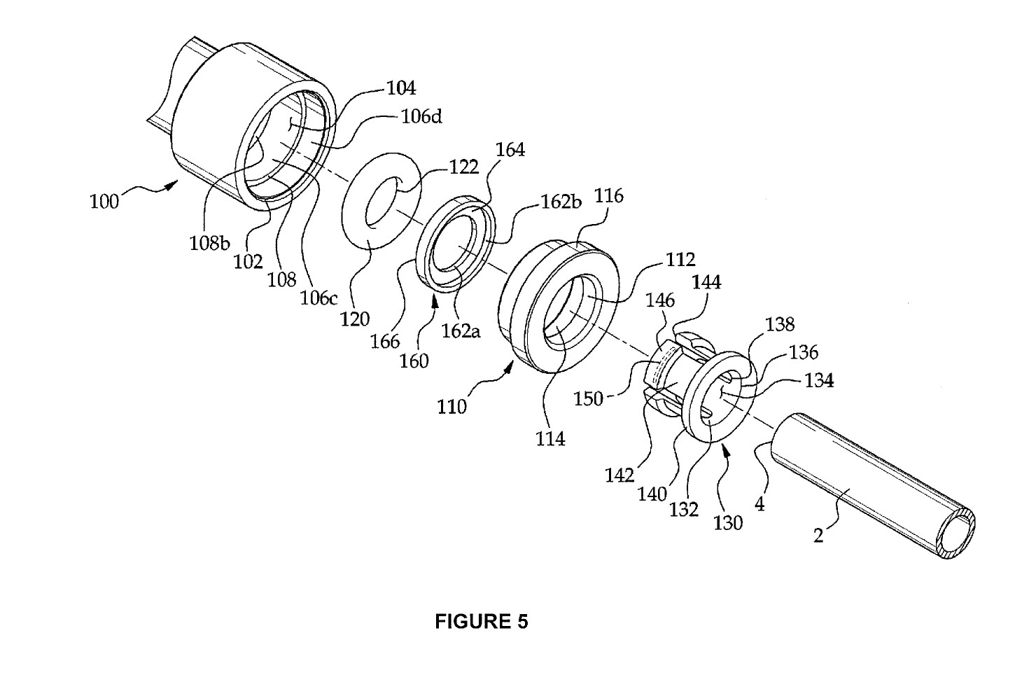

First, referring to FIGS. 3 through 5, a tube coupling according to the present invention includes a coupling body 100 for connecting tubes 2 for conveying various fluids such as water, oil, air, etc. The coupling body 100 includes a through pathway 104 having an open end 102 so as to accommodate each tube 2. The through pathway 104 has a first bore 106a, a second bore 106b, a third bore 106c, and a fourth bore 106d of which diameters are stepwise expanded along a flow direction of a fluid. The fourth bore 106d is connected to the open end 102. The first bore 106a is connected to the second bore 106b by a first step 108a for first expanding the diameter of the through pathway 104. The second bore 106b is connected to the third bore 106c by a second step 108b for second expanding the diameter of the through pathway 104. The third bore 10bc is connected to the fourth bore 106d by a third step 108c for third expanding the diameter of the through pathway 104. A tip 4 of the tube 2 is accommodated in the first bore 106a via the open end 102 and is retained on the first step 108a.

An end cap 110 is connected to the fourth bore 106d via the open end 102 of the coupling body 100. The end cap 110 has a hole 112 through which the tube 2 passes. A tapered bore 114 is formed in one side of the hole 112 in such a way that a diameter of the tapered bore 114 is gradually expanded towards a center of the coupling body 100. The end cap 110 has a flange 116 that is engaged with a periphery of the open end 102 of the coupling body 100. The coupling body 100 and the end cap 110 may be formed of thermoplastic resins. The end cap 110 may be bonded to the coupling body 100 so as to be able to be integrated with the coupling body 100 by using hot welding, ultrasonic welding, or the like. In addition, the coupling body 100 and the end cap 110 may be bonded to each other by using an adhesive or may be screw coupled.

The O-ring seal 120 is fitted to the through pathway 104 in order to maintain a hermetic seal between the tube 2 and the coupling body 100. A position of the O-ring seal 120 is defined by the second step 108b. The tube 2 is accommodated in the first bore 106a via a hole 122 of the O-ring seal 120. The O-ring seal 120 is formed to have an outer diameter at which the O-ring seal 120 does not pass through the hole 112 of the end cap 110 and is engaged with the tapered bore 114.

A collet 130 is connected to the through pathway 104 via the open end 102 of the coupling body 100. A sleeve 132 of the collet 130 is inserted in the through pathway 104 via the open end 102. The sleeve 132 has a hole 134 for passage of the tube 2, a first tip 136, and a second tip 138. A flange 140 is formed at an outer surface of the sleeve 132 that is adjacent to the first tip 136 in such a way that the flange 140 is engaged with the flange 116 of the end cap 110 and does not pass through the hole 112. A plurality of resilient arms 142 extend from the second tip 138 of the sleeve 132 and are inserted in the through pathway 104 via the open end 102. A plurality of heads 146 are formed on an outer surface adjacent to a tip 144 of each resilient arm 142. A round 148 is formed in front of the outer surface of the heads 146, and a cross-sectional area of the round 148 is decreased as the round 148 gets closer to the tip 144. The heads 146 may be smoothly inserted in the hole 112 of the end cap 110 by means of the round 148. A plurality of teeth 150 are provided in such a way that an outer surface of the tube 2 is engaged with an inner surface of the tube 2 adjacent to the tip 144 of each resilient arm 142 by means of the plurality of teeth 150. The collet 130 may be formed of thermoplastic resins, like in the coupling body 100 and the end cap 110. The teeth 150 may be formed of metal, such as stainless steel, alloy steel, or aluminum. The teeth 150 formed of metal are insert molded with the resilient arms 142.

The tube coupling according to the present invention includes a retainer ring 160 that is fitted to the through pathway 104 of the coupling body 100 so as to prevent the resilient arms 142 of the collet 130 from being separated from each other towards the outside. The retainer ring 160 is fitted so as to be able to move along the through pathway 104 between the O-ring seal 120 and the collet 130. The retainer ring 160 has a bore of small diameter 162a in which the tube 2 is inserted, and a bore of large diameter 162b that extends from the bore of small diameter 162a and houses the heads 146 by surrounding the heads 146 to ensure that there is no separation between the resilient arms 142. A step 164 is formed towards the open end 102 between the bore of small diameter 162a and the bore of large diameter 162b so as to be able to expand the diameter of the through pathway 104. The tip 144 of each resilient arm 142 is in contact with the step 164 so that a position of the retainer ring 160 is defined. The step 164 is formed as a plane that is perpendicular to a central axis of the retainer ring 160.

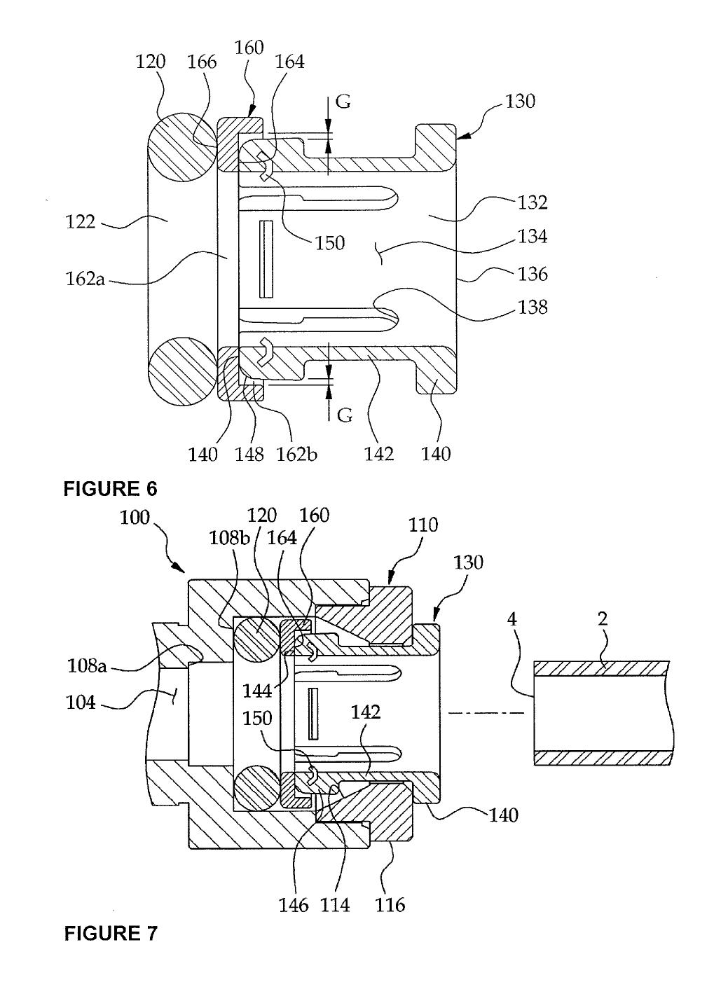

As illustrated in FIG. 6, a gap G is formed between the heads 146 and an inside of the bore of large diameter 162b so that the heads 146 are not in contact with the inside of the bore of large diameter 162b in initial states of the resilient arms 142, i.e., in a state where the resilient arms 142 are not deformed. The retainer ring 160 has a side surface 166 that faces the bore of large diameter 162b and the O-ring seal 120 contacts. The side 166 is formed as a plane that is perpendicular to the central axis of the retainer ring 160.

An operation of the tube coupling having the above structure according to the present invention will now be described.

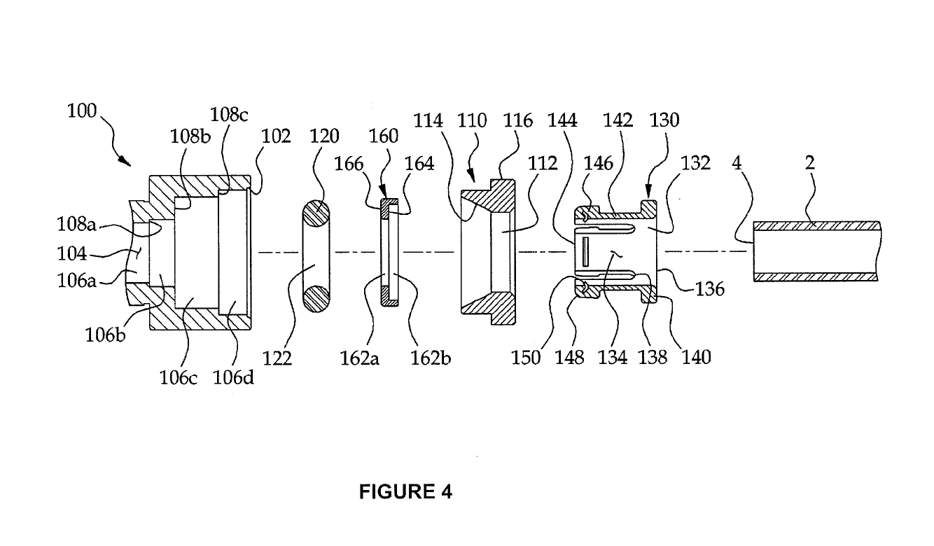

Referring to FIGS. 4 through 7, a worker mounts the O-ring seal 120 and the retainer ring 160 sequentially on the second bore 106b of the coupling body 100. A position of the O-ring seal 120 is retained on the second step 108b and thus is defined. The retainer ring 160 is fitted to the second bore 106b so that the step 164 of the retainer ring 160 is directed towards the open end 102 of the coupling body 100. The O-ring seal 120 is retained on the side surface 166.

The worker connects the end cap 110 to the fourth bore 106d via the open end 102 of the coupling body 100 after mounting the O-ring seal 120 and the retainer ring 160 on the second bore 106b of the coupling body 100. The flange 116 of the end cap 110 is retained on the periphery of the open end 102 of the coupling body 100. The worker inserts the resilient arms 142 of the collet 130 in the through pathway 104 of the coupling body 100 via the hole 112 of the end cap 110, and the tube 2 is inserted in the through pathway 104 of the coupling body 100 via the hole 134 of the collet 130. The tip 4 of the tube 2 is inserted in the second bore 106b via the hole 162 of the retainer ring 160 and the hole 122 of the O-ring seal 120 and is retained on the first step 108a. The coupling body 100 and the end cap 110 are bonded to each other so as to be able to be integrated with each other by using hot welding, ultrasonic welding, or the like.

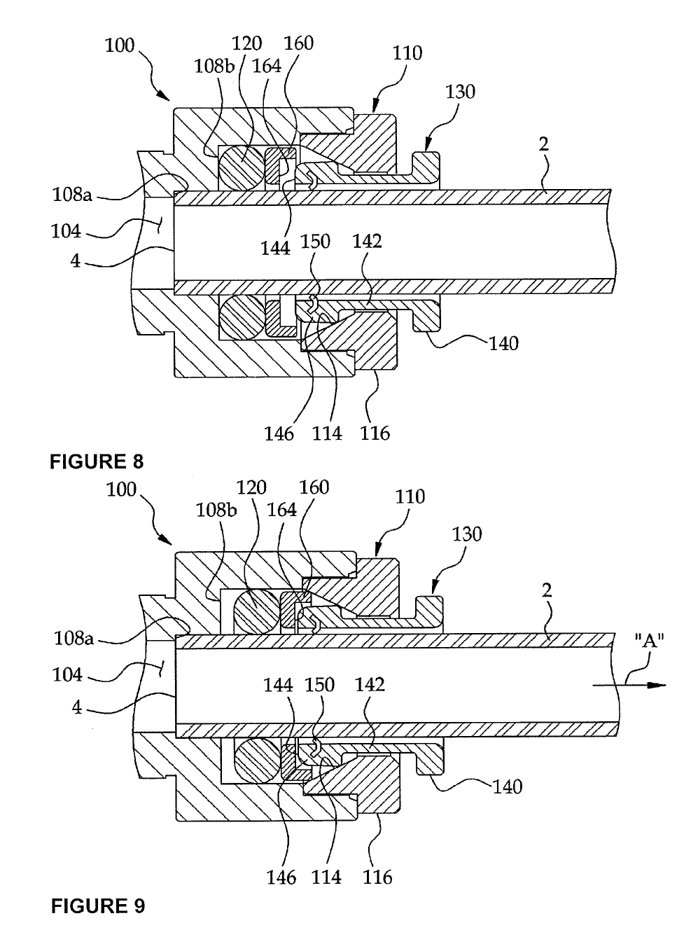

Referring to FIG. 8, the worker pulls out the flange 140 of the collet 130 after bonding the coupling body 100 and the end cap 110 to each other, thereby separating the flange 140 of the collet 130 from the open end 102. The flange 140 is pulled out by the worker so that the heads 146 are in contact with an inside of the tapered bore 114 and the collet 130 stops. The resilient arms 142 are folded in a state where the heads 146 are in contact with the inside of the tapered bore 114. When the resilient arms 142 are folded, the teeth 150 are securely engaged with the outer surface of the tube 2 so that the collet 130 is not depressed into the through pathway 104.

Referring to FIG. 9, a fluid to be supplied to the through pathway 104 of the coupling body 100, for example, a liquid such as water, oil, etc., is conveyed to the open end 102 via the tube 2, as indicated by arrow “A”. The O-ring seal 120 is pressed by a liquid pressure that is generated due to flow of the liquid. The O-ring seal 120 is pushed out from the second step 108b due to the liquid pressure and pushes the retainer ring 160, and the retainer ring 160 is moved to the fourth bore 106d along the third bore 106c. The tip 144 of each resilient arm 142 is in contact with the step 164 of the retainer ring 160 that is moved along the third bore 106c. Thus, the collet 130 is moved together with the retainer ring 160. When an excessive pressure is applied to the tip 144 of each resilient arm 142 due to the movement of the retainer ring 160 and the resilient arms 142 are separated from each other, the heads 146 are in contact with the inside of the bore of large diameter 162b, and separation of the resilient arms 142 is confined. Thus, deformation of the resilient arms 142 is prevented, and engagement of the tube 2 by means of the teeth 150 is securely maintained.

When the flange 140 of the collet 130 is in contact with the flange 116 of the end cap 110, as illustrated in FIG. 3, the heads 146 are detached from the inside of the tapered bore 114, and the resilient arms 142 are in their initial states, and engagement of the tube 2 by means of the teeth 150 is released. Thus, the worker may easily take the tube 2 from the hole 134 of the collet 130 by pulling out the tube 2. In this way, the tube coupling according to the present invention may perform connection and separation of the tube 2 conveniently and quickly.

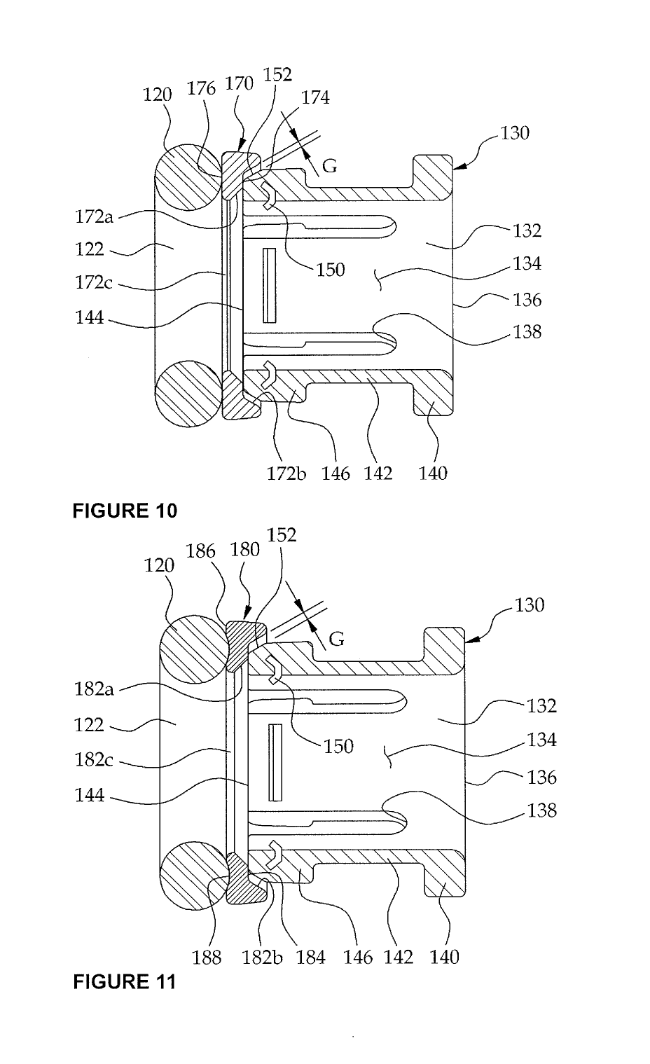

FIGS. 10 and 11 illustrate retainer rings of the tube coupling illustrated in FIG. 3, according to embodiments of the present invention. Referring to FIGS. 10 and 11, each of retainer rings 170 and 180 has bores of small diameter 172a and 182a and bores of large diameter 172b and 182b, which are sequentially formed along the flow direction of the fluid. An inclined surface 152 is formed in front of the outer surface of the heads 146, and a cross-sectional area of the inclined surface 152 is decreased as the inclined surface 152 gets closer to the tip 144. The heads 146 may be smoothly inserted in the hole 112 of the end cap 110 by means of the inclined surface 152. A gap G is formed between the heads 146 and an inside of each of the bores of large diameter 172b and 182b so that the heads 146 are not in contact with the inside of each of the bores of large diameter 172b and 182b in an initial state of the resilient arms 142, i.e., in a state where the resilient arms 142 are not deformed

The tube 2 is inserted in the through pathway 104 of the coupling body 100 via the bores of large diameter 172b and 182b and the bores of small diameter 172a and 182a of the retainer rings 170 and 180. Each of the bores of small diameter 172a and 182a is formed as a first tapered bore of which diameter is expanded towards the open end 102 so that entry of the tube 2 may be precisely guided to the hole 122 of the O-ring seal 102. Each of the bores of large diameter 172b and 182b is formed as a second tapered bore, of which diameter is expanded towards the open end 102. The second tapered bore is not in contact with the outer surface of the heads 146 in initial states of the resilient arms 142. Third tapered bores 172c and 182c are formed in such a way that diameters of the third tapered bores 172c and 182c are expanded from the bores 172a and 182a of small diameter in a direction opposite to directions of the bores 172b and 182b of large diameter. The third tapered bores 172c and 182c guide the tip 4 of the tube 2 that passes through the bores 172a and 182a of small diameter to the hold 122 of the O-ring seal 120.

Steps 174 and 178 for expanding the diameter of the through pathway 104 are formed between the bores of small diameter 172a and 182a and the bores of large diameter 172b and 182b. The tip 144 of each resilient arm 142 is in contact with the steps 174 and 184 and thus, a position of each of the retainer rings 170 and 180 is defined. Each of the steps 174 and 184 is formed as a plane that is perpendicular to a central axis of each of the retainer rings 170 and 180. Each of the retainer rings 170 and 180 has each of side surfaces 176 and 186 that face each of the bores of large diameter 172b and 182b and the O-ring seal 120 contacts. Each of the side surfaces 176 and 186 is formed as a plane that is perpendicular to the central axis of each of the retainer rings 170 and 180.

As illustrated in FIG. 11, a seal seat 188 is formed at the side surface 186 of the retainer ring 180 so that the O-ring seal 120 may be seated on the seal seat 188. The seal seat 188 is formed as a semi-circular groove with which the outer surface of the O-ring seal 120 is partially engaged. The O-ring seal 120 is stably and closely seated on the seal seat 188 so that a hermetic seal property of the tube coupling may be improved.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

As described above, in a tube coupling according to the present invention, resilient arms of a collet are not excessively separated from each other by confinement of a retainer ring, and plastic deformation of the resilient arms is prevented, and a fluid is safely conveyed without leakage so that a reliability of the tube coupling may be improved and a life span of the tube coupling may be guaranteed. Thus, the tube coupling may be very usefully employed in a fluid pipeline of a water supplying device for providing a beverage, such as a water purifier, an oil pipeline for supplying oil, an air pipeline for supplying air, and the like.

1. A tube coupling comprising:
a coupling body comprising a through pathway having an open end so as to connect tubes for conveying a fluid and a step that is formed in the through pathway towards the open end so as to expand a diameter of the through pathway;
an end cap that is connected to the through pathway via the open end and comprises a tapered bore through which the tube passes, wherein a diameter of the tapered bore is expanded towards the step of the coupling body;
an O-ring seal that is fitted to the through pathway so as to maintain a hermetic seal between the coupling body and the tube, wherein a position of the O-ring seal is defined by the step of the coupling body;
a collet comprising a sleeve through which the tube passes and a plurality of resilient arms extending from the sleeve so as to be able to be inserted in the through pathway, wherein a plurality of heads are formed so as to be able to be in contact with the tapered bore on an outer surface adjacent to a tip of each of the resilient arms, and a plurality of teeth are provided on an inner surface of the tube adjacent to the tip of each resilient arm so that an outer surface of the tube is engaged with the inner surface of the tube adjacent to the tip of each resilient arm; and
a retainer ring that is fitted so as to be able to move along the through pathway between the O-ring seal and the collet, has a bore of small diameter where the tube is inserted and a bore of large diameter housing the heads to ensure that there is no separation between the resilient arms, and has a step that is formed between the bore of small diameter and the bore of large diameter such that tips of the resilient arms are in contact with the step.

2. The tube coupling of claim 1, wherein a gap is formed between the heads and an inside of the bore of large diameter so that the heads are not in contact with the inside of the bore of large diameter in initial states of the resilient arms.

3. The tube coupling of claim 2, wherein the step of the retainer ring is formed as a plane that is perpendicular to a central axis of the retainer ring.

4. The tube coupling of claim 1, wherein the retainer ring has a side surface that the O-ring seal contacts, and the side surface of the retainer ring is formed as a plane that is perpendicular to a central axis of the retainer ring.

5. The tube coupling of claim 1, wherein the retainer ring has a side surface that the O-ring seal contacts, and a seal seat is formed at the side surface of the retainer ring so that the O-ring seal is seated on the seal seat.

6. The tube coupling of claim 1, wherein the bore of small diameter is formed as a first tapered bore of which diameter is expanded towards the open end so as to guide entry of the tube via a hole of the O-ring seal.

7. The tube coupling of claim 6, wherein the bore of large diameter is formed as a second tapered bore of which diameter is expanded towards the open end so as to house the heads.

8. The tube coupling of claim 6, wherein a third tapered bore of which diameter is expanded from the bore of small diameter in a direction opposite to the bore of large diameter, is formed.
